(19) United States
(12) Patent Application Publication
(10) Pub. No.: US 2020/0047382 A1
(43) Pub. Date: Feb. 13, 2020

(54) LAMINATE, DECORATIVE SHEET, METHOD FOR PRODUCING LAMINATE, METHOD FOR PRODUCING MOLDED BODY, AND MOLDED BODY

(71) Applicant: IDEMITSU UNITECH CO., LTD., Tokyo (JP)

(72) Inventors: Tatsuro MATSUURA, Chiba (JP); Kaname KONDO, Chiba (JP)

(73) Assignee: IDEMITSU UNITECH CO., LTD., Tokyo (JP)

(21) Appl. No.: 16/486,015

(22) PCT Filed: Feb. 13, 2018
(86) PCT No.: PCT/JP2018/004872

§ 371 Date: Aug. 14, 2019

(30) Foreign Application Priority Data
Feb. 14, 2017 (JP) 2017-024921

(51) Int. Cl. B29C 45/14; B29C 48/18

(52) U.S. Cl. CPC B29C 45/14; B29C 51/12; B29C 48/18

(57) ABSTRACT

A laminate which comprises a first resin layer and a second resin layer, and wherein: a resin constituting the first resin layer and a resin constituting the second resin layer are incompatible with each other, the first resin layer contains a polyolefin; the second resin layer contains a first thermoplastic resin and a second thermoplastic resin; and the first thermoplastic resin and the second thermoplastic resin are incompatible with each other, while having different solidification temperatures.

### TECHNICAL FIELD

The invention relates to a laminate, a decorative sheet, a method for producing the laminate, a method for producing a molded body, and the molded body.

### BACKGROUND ART

As a technology for decorating a molded body such as a vehicle interior material and a household appliance housing, an insert molding method or an in-mold molding method is used. According to these techniques, a decorative sheet for decoration and a housing (injection resin) are integrally molded, whereby a decorative molded body can be produced.

Further, a technology for providing the molded body with design performance by using a decorative sheet provided with an uneven shape by embossing or the like is also used. The uneven shape is provided by pressing a transfer roll (embossing roll) engraved with an uneven pattern onto the decorative sheet (melted resin), for example.

Patent Document 1 discloses a method for producing a decorative molded body using artificial leather with a protection film formed of: the artificial leather containing a nonwoven fabric of an ultrafine fiber, and a resin layer having an embossed uneven surface as a three-dimensional decorative surface; and the protection film formed by coating a resin so as to fill concave portions of the embossed uneven surface.

Patent Document 2 discloses a simultaneous molding and decorating sheet, in which a thermoplastic substrate sheet is laminated on a side of an embossed surface of a thermoplastic resin release sheet subjected to embossing in at least part of one surface thereof, and a decorative layer is formed on a surface on a side opposite to a surface laminated with the release sheet across the substrate sheet.

Patent Document 3 discloses a method for producing a film used for a capacitor element or the like, in which a film-shaped melted resin formed of a mixture of two or more kinds of specific thermoplastic resins is extruded onto a film-shaped melted resin formed of polyvinylidene fluoride or a vinylidene fluoride copolymer in a state of adhered lamination form, the resulting material is cooled and solidified, and then stretched to peel a film formed of the latter film-shaped melted resin therefrom.

### RELATED ART DOCUMENTS

### Patent Documents

Patent Document 1: JP-A-2016-124156

Patent Document 2: JP-A-2008-137215

Patent Document 3: JP-A-S63-243143

### SUMMARY OF THE INVENTION

An uneven processing technology using a transfer roll has an issue in a transfer ratio to a decorative sheet, and has a problem of causing transfer void according to which transfer becomes imperfect. Further, if secondary processing involving heating (for example, vacuum and pressure forming, insert molding, in-mold molding) is performed, an uneven shape is lost or reduced, and the technology has a problem of reduction of design performance of the decorative sheet. On the other hand, if a protection film or a release sheet is formed in order to suppress the uneven shape from being lost or reduced (Patent Documents 1, 2), the technology has a problem of increasing the number of production steps.

An object of the invention is to provide a laminate comprising a decorative sheet, in which the design performance of the decorative sheet is not adversely affected even if molding involving heating is performed, and the laminate can be produced in the small number of steps.

The present inventors have diligently continued to conduct research, and as a result, have found that a first resin layer containing a polyolefin and a second resin layer containing two or more kinds of specific thermoplastic resins are co-extruded and cooled, whereby a laminate having an uneven shape formed in an interface between the first resin layer and the second resin layer is obtained, and that the second resin layer is peeled from the laminate, whereby the uneven shape is exposed, and a decorative sheet suitable for providing the design performance is obtained. The laminate can be prepared in the significantly small number of steps, and further the second resin layer functions as a protective layer of the uneven shape, and therefore even if molding involving heating is performed, the design performance can be maintained.

According to the invention, the laminate and the like described below are provided.

1. A laminate, comprising a first resin layer and a second resin layer,

wherein a resin constituting the first resin layer and a resin constituting the second resin layer are incompatible with each other,

the first resin layer contains a polyolefin,

the second resin layer contains a first thermoplastic resin and a second thermoplastic resin, and

the first thermoplastic resin and the second thermoplastic resin are incompatible with each other, while having different solidification temperatures.

2. The laminate according to 1, wherein the second resin layer has a sea-island structure in which the first thermoplastic resin constitutes a sea portion and the second thermoplastic resin constitutes an island portion.

3. The laminate according to 1, wherein the solidification temperature of the first thermoplastic resin is higher than the solidification temperature of the second thermoplastic resin.

4. The laminate according to any one of 1 to 3, wherein an interface between the first resin layer and the second resin layer partly or wholly has an uneven shape.

5. The laminate according to any one of 1 to 4, wherein the laminate can be separated in the interface between the first resin layer and the second resin layer.

6. The laminate according to any one of 1 to 5, wherein the first thermoplastic resin of the second resin layer contains one or more resins selected from the group consisting of polystyrene, polyacrylonitrile, polyamide, an ethylene-vinyl alcohol copolymer, polyethylene terephthalate, a polyolefin and polylactic acid.

7. The laminate according to any one of 1 to 6, wherein the second thermoplastic resin of the second resin layer contains a rubber-like polymer.

8. The laminate according to 7, wherein the rubber-like polymer is one or more selected from the group consisting of diene-based rubber, a thermoplastic elastomer and an ionomer.

9. The laminate according to any one of 1 to 8, wherein the first resin layer contains polypropylene.

10. The laminate according to 9, wherein a crystallization rate of the polypropylene at 130° C. is 2.5 min⁻¹ or less.

11. The laminate according to 9 or 10, wherein the polypropylene contains a smectic form.

12. The laminate according to any one of 9 to 11, wherein the polypropylene has an exothermic peak having 1 J/g or more on a low-temperature side of a maximum endothermic peak in a curve obtained by differential scanning calorimetry.

13. The laminate according to any one of 9 to 12, wherein an isotactic pentad fraction of the polypropylene is 85 mol % to 99 mol %.

14. The laminate according to any one of 1 to 13, comprising a third resin layer containing a polyolefin on a side opposite to the first resin layer across the second resin layer.

15. The laminate according to 14, wherein the first resin layer and the third resin layer contain a modified polyolefin, and a content proportion of the modified polyolefin in the third resin layer is higher than a content proportion of the modified polyolefin in the first resin layer.

16. The laminate according to 15, wherein the modified polyolefin contained in the first resin layer is identical to the modified polyolefin contained in the third resin layer.

17. The laminate according to any one of 1 to 16, comprising a fourth resin layer containing one or more resins selected from the group consisting of urethane, acryl, a polyolefin and polyester, on a side opposite to the second resin layer across the first resin layer.

18. The laminate according to 17, wherein tensile elongation at break of the fourth resin layer is 150% or more and 900% or less, and a softening temperature thereof is 50° C. or higher and 180° C. or lower.

19. The laminate according to 17 or 18, comprising a printed layer on a side opposite to the first resin layer across the fourth resin layer.

20. The laminate according to 17 or 18, comprising a metal layer containing metal or metal oxide on a side opposite to the first resin layer across the fourth resin layer.

21. A decorative sheet, obtained by peeling the second resin layer, or the second resin layer and the third resin layer from the laminate according to any one of 1 to 20.

22. A method for producing a laminate comprising a first resin layer and a second resin layer, comprising a step of producing a laminated sheet by co-extruding a resin constituting the first resin layer and a resin constituting the second resin layer, and a step of cooling the laminated sheet,

wherein the resin constituting the first resin layer and the resin constituting the second resin layer are incompatible with each other,

the resin constituting the first resin layer contains a polyolefin,

the resin constituting the second resin layer contains a first thermoplastic resin and a second thermoplastic resin, and

the first thermoplastic resin and the second thermoplastic resin are incompatible with each other, while having different solidification temperatures.

23. The method for producing the laminate according to 22, wherein, in the step of producing the laminated sheet, in addition to the resin constituting the first resin layer and the resin constituting the second resin layer, a resin constituting a third resin layer is co-extruded to produce a laminate comprising the first resin layer, the second resin layer and the third resin layer.

24. The method for producing the laminate according to 22 or 23, comprising, after the step of cooling the laminated sheet, a step of laminating a fourth resin layer containing one or more resins selected from the group consisting of urethane, acryl, a polyolefin and polyester, on a side opposite to the second resin layer across the first resin layer.

25. The method for producing the laminate according to 24, comprising a step of applying printing on a side opposite to the first resin layer across the fourth resin layer.

26. The method for producing the laminate according to 24, comprising a step of forming a metal layer containing metal or metal oxide on a side opposite to the first resin layer across the fourth resin layer.

27. A method for producing a molded body, comprising a step of molding the laminate according to any one of 1 to 20, and a step of peeling the second resin layer, or the second resin layer and the third resin layer from the molded laminate.

28. A method for producing a molded body, comprising a step of peeling the second resin layer, or the second resin layer and the third resin layer from the laminate according to any one of 1 to 20 to obtain a decorative sheet, and a step of molding the decorative sheet.

29. The method for producing the molded body according to 27 or 28, wherein the molding is performed by attaching the laminate or the decorative sheet to a mold, and supplying a molding resin to integrate the molding resin with the laminate or the decorative sheet.

30. The method for producing the molded body according to 27 or 28, wherein the molding is performed by shaping the laminate or the decorative sheet so as to match a mold, attaching the shaped laminate to the mold, and supplying a molding resin to integrate the molding resin with the shaped laminate.

31. The method for producing the molded body according to 27 or 28, wherein
the molding comprising:
arranging a core material in a chamber box;
arranging the laminate or the decorative sheet above the core material;
reducing pressure in the chamber box;
heating and softening the laminate or the decorative sheet; and
pressing the heated and softened laminate or decorative sheet to the core material to coat the core material with the laminate or the decorative sheet.

32. A molded body, obtained by the method for producing the molded body according to any one of 27 to 31.

The invention can provide a laminate which comprises a decorative sheet, in which the design performance of the decorative sheet is not adversely affected even if molding involving heating is performed, and the laminate can be produced in the small number of steps.

### BRIEF DESCRIPTION OF THE DRAWINGS

FIG. 1 is a schematic cross-sectional view of a laminate according to one embodiment of the invention.

FIG. 2 is a schematic cross-sectional view of a laminate according to one embodiment of the invention.

FIG. 3 is a schematic cross-sectional view of a laminate according to one embodiment of the invention.

FIG. 4 is a schematic view of an apparatus used for production of a laminate in Example 1.

FIG. 5 is an observed image of a surface shape of a decorative sheet in Example 1.

FIG. 6 is an observed image of a surface shape of a second resin layer peeled on a side of a first resin layer in Example 1.

FIG. 7 is an observed image of a surface shape of a decorative sheet in Example 2.

### MODE FOR CARRYING OUT THE INVENTION

### [Laminate]

A laminate according to one aspect of the invention comprises a first resin layer and a second resin layer. A resin constituting the first resin layer and a resin constituting the second resin layer are incompatible with each other. The first resin layer contains a polyolefin, and the second resin layer contains a first thermoplastic resin and a second thermoplastic resin which are incompatible with each other, while having solidification temperature different from each other.

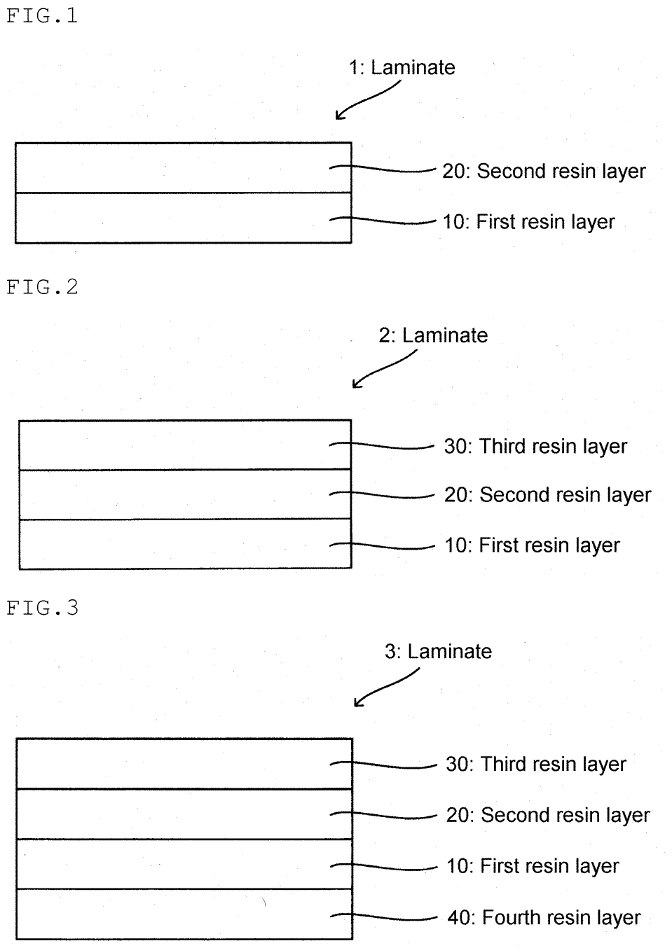

FIG. 1 shows a laminate according to one embodiment of the invention.

In FIG. 1, a laminate 1 comprises a first resin layer 10 and a second resin layer 20 formed thereon. Here, FIG. 1 is only for illustrating a layer structure, and an aspect ratio or a film thickness ratio is not necessarily accurate.

In the laminate according to one aspect of the invention, the second resin layer preferably has a sea-island structure (matrix-domain structure) formed of a sea portion (matrix) containing the first thermoplastic resin, and an island portion (domain) containing the second thermoplastic resin. A fine uneven shape by the sea-island structure partly or wholly exists on a surface of the second resin layer on a side of the first resin layer. In corresponding thereto, on a surface of the first resin layer on a side of the second resin layer, a fine uneven shape in a reversed form of the relevant fine uneven shape is partly or wholly formed (the relevant uneven shape is not shown in FIG. 1).

The second resin layer is peeled from the laminate, whereby a resin sheet having the fine uneven shape on the surface (first resin layer) can be obtained. Design is expressed by the uneven shape, and therefore the resin sheet can be used as a decorative sheet.

The term “decorative sheet” means a sheet for decorating a molded body used as an interior material of a vehicle or a housing of a household appliance, for example, to provide the molded body with design performance. The decorative sheet is integrated with a molding resin, whereby the molded body provided with a shape of a surface of the decorative sheet or the design can be produced.

In the laminate according to one aspect of the invention, an uneven shape is formed by using a specific component in the second resin layer. Therefore, as described later, the laminate can be produced in the significantly small number of steps without requiring a transfer step by the transfer roll (embossing roll). Further, in a state of the laminate, the uneven shape of the first resin layer adheres with the uneven shape of the second resin layer, and the second resin layer functions as a protective layer of the uneven shapes, and therefore even if secondary processing involving heating is performed, deformation or extinction of the uneven shape is not caused, or the deformation or the like can be minimized. Further, the transfer roll is not used, and therefore a defect such as transfer void is not caused. Further, transferability of the uneven shape by the second resin layer is high, and therefore a desired uneven shape can be easily obtained.

Hereinafter, each layer that forms the laminate according to one aspect of the invention will be described. In the present description, the term “x to y” shall express the range of numerical values of “x or more and y or less.”

### (First Resin Layer)

The first resin layer contains a polyolefin. Specific examples of the polyolefin include polyethylene, polypropylene and a cyclic polyolefin resin, and particularly preferably polypropylene from viewpoints of heat resistance and hardness.

The polypropylene is a polymer containing a structural unit derived from at least propylene. Specific examples thereof include homopolypropylene and a copolymer of propylene with any other olefin (ethylene, butylene, cycloolefin or the like). The polypropylene may be formed into a mixture in which a polyolefin such as polyethylene (for example, linear low-density polyethylene) or the copolymer is mixed with the polypropylene.

A polypropylene copolymer may be random polypropylene or block polypropylene, or may be a mixture thereof.

These polymers may be used in one kind alone, or in combination of two or more kinds.

If the polypropylene contains a smectic form, such polypropylene is preferred.

The polypropylene is a crystalline resin, and can take a crystal form such as an α form, a β form, a γ form, and a smectic form. Among these crystal forms, the smectic form can be formed as an intermediate between an amorphous state and a crystalline state by cooling the polypropylene at a rate of 80° C. or more per second from a melted state. A structure of the smectic form is not a stable structure having an ordered structure such as a crystal, but is a metastable structure in which fine structures are assembled. Therefore, the smectic form has weak intermolecular chain interaction, and has properties of being further easily softened upon heating, in comparison with the a form having the stable structure, or the like.

A crystal structure of the polypropylene is measured by the method described in Examples.

Further, the first resin layer preferably contains no nucleating agent. Even when the first resin layer contains a nucleating agent, a content of the nucleating agent in the first resin layer is 1.0% by mass or less, and preferably 0.5% by mass or less.

Examples of the nucleating agent include a sorbitol-based nucleating agent, and specific examples of a commercial item thereof include GEL ALL MD (New Japan Chemical Co., Ltd.) and Rikemaster FC-1 (Riken Vitamin Co., Ltd.).

In order to form the polypropylene, which is the crystalline resin, into a transparent product, specific examples include a method of cooling a laminate at 80° C. or more per second to form a smectic form in producing the laminate, and a method of adding a nucleating agent to compulsorily form fine crystals. The nucleating agent enhances a crystallization rate of the polypropylene to a rate more than 2.5 min⁻¹ to form a great number of crystals to fill a space, thereby physically eliminates the space in which the crystals grow to reduce sizes of the crystals. However, the nucleating agent has materials serving as nuclei present therein, and therefore the product slightly turns whitish even if the transparent product is formed, and the design performance is liable to be reduced.

Accordingly, the crystallization rate (130° C.) of the polypropylene is adjusted to 2.5 min⁻¹ or less, and the polypropylene is cooled at 80° C. or more per second to form the smectic form, without adding the nucleating agent, whereby the laminate excellent in the design performance can be obtained. The crystallization rate of the polypropylene is more preferably 2.0 min⁻¹ or less. The crystallization rate is measured by the method described in Examples.

Further, a scattering intensity distribution and a long period are calculated by a small-angle X-ray scattering analysis method, whereby whether or not the laminate (decorative sheet) is a material obtained by cooling at 80° C. or more per second can be judged. More specifically, according to the above-described analysis, whether or not the laminate (decorative sheet) has the fine structure derived from the smectic form can be judged.

Measurement is performed under the conditions described below.

As an X-ray generator, UltraX 18HF (manufactured by Rigaku Corporation) is used, and an imaging plate is used for detection of scattering.
Light source wavelength: 0.154 nm
Voltage/current: 50 kV/250 mA
Irradiation time: 60 minutes
Camera length: 1.085 m
Sample thickness: sheets are stacked to be 1.5 to 2.0 mm. Further, the sheets are stacked so as to align film-forming (MD) directions.

In the polypropylene, if an isotactic pentad fraction is 85 mol % to 99 mol %, such polypropylene is preferred from a viewpoint of scratch resistance.

The term “isotactic pentad fraction” means an isotactic fraction in a pentad unit (5 propylene monomers are continuously linked in an isotactic sequence) in molecular chains of a resin composition. A measuring method of the fraction is described in Macromolecules, vol. 8, p. 687 (1975), for example. The fraction can be measured by ¹³C-NMR.

The isotactic pentad fraction of the polypropylene is preferably 85 mol % to 99 mol %, and more preferably 90 mol % or more. If the isotactic pentad fraction is 85 mol % or more, the laminate has sufficient surface hardness, and therefore a surface of the laminate is hard to be scratched and appearance can be kept.

On the other hand, polypropylene having a high isotactic pentad fraction has a high degree of crystallization, and therefore is formed into an opaque sheet in several cases, unless the nucleating agent is added thereto or the method of cooling at a rate of 80° C. or more per second, or the like is used upon producing the sheet described later.

The conditions are within the above-described range, whereby transparency can be obtained, and the laminate can be favorably and easily decorated.

The isotactic pentad fraction is measured by the method described in Examples.

The polypropylene has an exothermic peak having preferably 1.0 J/g or more, and more preferably 1.5 J/g or more on a low-temperature side of a maximum endothermic peak in a curve of differential scanning calorimetry. The differential scanning calorimetry is measured by the method described in Examples.

In the polypropylene, a melt flow index (MI) is preferably 0.5 g/10 min or more and 5.0 g/10 min or less, more preferably 1.5 g/10 min or more and 4.5 g/10 min or less, and further preferably 2.0 g/10 min or more and 4.0 g/10 min or less.

If MI is 0.5 g/10 min or more, shear stress in a die slip portion during extrusion molding is appropriate, and sufficient translucency can be secured. If MI is 5.0 g/10 min or less, the polypropylene is excellent in moldability.

MI is measured at a measuring temperature of 230° C. and a load of 2.16 kg in accordance with JIS K 7210.

The first resin layer may contain a modified polyolefin in addition to the polyolefin. The modified polyolefin is a modified product by a modifying compound for the polyolefin. The polyolefin is as described above, and specific examples thereof include homopolypropylene, homopolyethylene, a copolymer of propylene and olefin, a copolymer of ethylene and olefin, and polycycloolefin. These polymers may be used in one kind alone, or in combination of two or more kinds.

Specific examples of the modifying compound include maleic anhydride, dimethyl maleate, diethyl maleate, acrylic acid, methacrylic acid, tetrahydrophthalic acid, carboxylic acid, glycidyl methacrylate, hydroxyethyl methacrylate and methyl methacrylate.

A proportion of the modified polyolefin to all materials constituting the first resin layer may be adjusted to 0 to 30% by mass, 0 to 25% by mass, 5 to 24% by mass or 10 to 22% by mass.

For example, 70% by mass or more, 80% by mass or more, 90% by mass or more, 98% by mass or more, 99% by mass or more or 99.9% by mass or more of the first resin layer may be the polyolefin, or the polyolefin and the modified polyolefin. The first resin layer may consist essentially of the polyolefin, or the polyolefin and the modified polyolefin. In this case, the first resin layer may contain inevitable impurities. The first resin layer may consist of the polyolefin, or the polyolefin and the modified polyolefin.

The resin constituting the first resin layer and the resin constituting the second resin layer described later are incompatible with each other. The expression “the resin constituting the first resin layer and the resin constituting the second resin layer are incompatible with each other” means that, when these resins are melted and mixed at 180° C. to 280° C., no single phase is formed.

In addition to the above-described components, an additive such as a pigment, an antioxidant, a stabilizer and an ultraviolet absorber may be blended, when necessary, in the first resin layer.

A thickness of the first resin layer is preferably 60 to 250 μm, and more preferably 75 to 220 μm.

### (Second Resin Layer)

The second resin layer contains the first thermoplastic resin and the second thermoplastic resin, and these thermoplastic resins are incompatible with each other.

The expression “the first thermoplastic resin and the second thermoplastic resin are incompatible with each other” means that, when these resins are melted and mixed at 180° C. to 280° C., no single phase is formed.

The first thermoplastic resin and the second thermoplastic resin have the solidification temperatures different from each other.

The term “solidification temperature” means a crystallization temperature in the case of a crystalline thermoplastic resin, and a glass transition temperature in the case of a noncrystalline thermoplastic resin.

The expression “the solidification temperatures different from each other” means that the crystallization temperatures are different from each other in the case of the crystalline thermoplastic resins, and the glass transition temperatures are different from each other in the case of the noncrystalline thermoplastic resins, and the crystallization temperatures and the glass transition temperatures are different from each other in the case of the crystalline thermoplastic resins and the noncrystalline thermoplastic resins.

The crystallization temperature and the glass transition temperature are measured by using a differential scanning calorimeter in accordance with JIS K 7121.

The solidification temperature of the first thermoplastic resin may be higher or lower than the solidification temperature of the second thermoplastic resin. The solidification temperature of the first thermoplastic resin is separated from the second thermoplastic resin preferably by 50° C. or more, and more preferably by 70° C. or more, and may be separated therefrom by 100° C. or more or 150° C. or more.

The second resin layer preferably has the sea-island structure (matrix-domain structure) in which a dispersed phase (island portion, domain) containing the second thermoplastic resin is dispersed in a continuous phase (sea portion, matrix) containing the first thermoplastic resin. The fine uneven shape by the sea-island structure preferably partly or wholly exists on the surface of the second resin layer.

Presence or absence of the sea-island structure is confirmed by observing the surface with a transmission electron microscope (TEM). When the sea-island structure is difficult to be distinguished, either the continuous phase or the dispersed phase is electron-stained by using osmium tetroxide, ruthenium tetroxide or tungstophosphoric acid, and the surface is observed. An observation sample is preferably observed by cross-sectionally cutting the sample with a microtome or the like.

The first thermoplastic resin may be the crystalline thermoplastic resin or the noncrystalline thermoplastic resin, but is preferably the crystalline thermoplastic resin.

Specific examples of the first thermoplastic resin include polystyrene, polyacrylonitrile, polyamide, an ethylene-vinyl alcohol copolymer, polyethylene terephthalate, a polyolefin and polylactic acid.

The second thermoplastic resin may be the crystalline thermoplastic resin or the noncrystalline thermoplastic resin, but is preferably the noncrystalline thermoplastic resin.

As the second thermoplastic resin, a rubber-like polymer can be used, for example.

As the rubber-like polymer, a rubber-like polymer such as diene-based rubber, non-diene-based rubber, a thermoplastic elastomer and an ionomer resin can be used, for example.

Specific examples of the diene-based rubber-like polymer include polybutadiene, a butadiene-styrene copolymer, a styrene-butadiene-styrene copolymer, polyisoprene and polychloroprene.

Specific examples of the non-diene-based rubber-like polymer include an acrylic rubber-like polymer (for example, poly(propyl (meth)acrylate), poly(butyl (meth)acrylate) or the like) and an olefin-based polymer (for example, a styrene-propylene copolymer or the like).

Specific examples of the thermoplastic elastomer include an amide-based elastomer, a urethane-based elastomer, an ester-based elastomer, an olefin-based elastomer and a styrene-based elastomer.

Specific examples of the ionomer resin include an olefin-based ionomer resin, a urethane-based ionomer resin and a fluorine-based ionomer resin.

It is preferable that the first thermoplastic resin is the crystalline thermoplastic resin, and the second thermoplastic resin is the noncrystalline thermoplastic resin.

Specific examples of the resin containing the first thermoplastic resin and the second thermoplastic resin include high impact polystyrene (HIPS), an acrylonitrile-butadiene-styrene copolymer (ABS resin), an acrylonitrile-styrene-acryl copolymer (AAS resin), an acrylonitrile-styrene-ethylene copolymer (AES resin), a methyl methacrylate-butadiene-styrene copolymer (MBS resin) and a methyl methacrylate-acrylonitrile-butadiene-styrene copolymer (MABS resin).

A proportion of the second thermoplastic resin to the total amount of the first thermoplastic resin and the second thermoplastic resin is 5 to 40% by mass, and preferably 10 to 30% by mass, for example.

The second resin layer may contain a modifying resin in addition to the above-described components.

The modifying resin is not particularly limited, as long as the modifying resin forms a bond with the modified polyolefin to improve adhesion when the first resin layer and/or a third resin layer contains the modified polyolefin. Specific examples thereof include a resin (for example, polystyrene) containing a group derived from oxazoline, maleic anhydride, dimethyl maleate, diethyl maleate, acrylic acid, methacrylic acid, tetrahydrophthalic acid, glycidyl methacrylate, hydroxyethyl methacrylate, methyl methacrylate and the like.

Further, the modifying resin is preferably a resin compatible with the first thermoplastic resin and the second thermoplastic resin contained in the second resin layer.

For example, 70% by mass or more, 80% by mass or more, 90% by mass or more, 98% by mass or more, 99% by mass or more or 99.9% by mass or more of the second resin layer may be the first thermoplastic resin, the second thermoplastic resin and the modifying resin. The second resin layer may consist essentially of the first thermoplastic resin, the second thermoplastic resin and the modifying resin. In this case, the second resin layer may contain inevitable impurities. The second resin layer may consist of the first thermoplastic resin, the second thermoplastic resin and the modifying resin.

A thickness of the second resin layer is preferably 2 to 50 μm, and more preferably 2 to 30 μm.

### (Third Resin Layer)

The laminate according to one embodiment of the invention may comprise the third resin layer containing the polyolefin on a side opposite to the first resin layer across the second resin layer.

The polyolefin is as described in the first resin layer.

FIG. 2 shows a laminate according to one embodiment of the invention.

In FIG. 2, a laminate 2 comprises a first resin layer 10, a second resin layer 20 formed thereon, and a third resin layer 30 formed thereon. Here, FIG. 2 is only for illustrating a layer structure, and an aspect ratio or a film thickness ratio is not necessarily accurate.

The third resin layer is provided thereon, whereby rigidity and handling properties of the laminate can be improved. Further, a deteriorated product is suppressed from being deposited on extruder dies, a guide roll or the mold.

The third resin layer may contain a modified polyolefin. The modified polyolefin is as described in the first resin layer. The modified polyolefin contained in the first resin layer and the modified polyolefin contained in the third resin layer may be identical to or different from each other, but is preferably identical to each other.

A proportion of the modified polyolefin to all materials constituting the third resin layer may be adjusted to 20 to 50% by mass, 25 to 45% by mass, 27 to 40% by mass or 28 to 38% by mass.

Here, a content proportion of the modified polyolefin in the third resin layer is preferably higher than a content proportion of the modified polyolefin in the first resin layer. The content proportion of the modified polyolefin in the third resin layer is preferably higher by 5% by mass to 25% by mass, and more preferably higher by 7% by mass to 20% by mass, than the content proportion of the modified polyolefin in the first resin layer. Thus, a modification ratio of the third resin layer becomes higher than a modification ratio of the first resin layer, and therefore adhesion strength between the second resin layer and the third resin layer becomes larger than adhesion strength between the first resin layer and the second resin layer, whereby the laminate is easily selectively separated in the interface between the first resin layer and the second resin layer.

Further, an acid number of the resin constituting the third resin layer is preferably higher than an acid number of the resin constituting the first resin layer. Thus, the laminate is easily selectively separated in the interface between the first resin layer and the second resin layer. The acid number can be measured by a neutralization titration method.

For example, 70% by mass or more, 80% by mass or more, 90% by mass or more, 98% by mass or more, 99% by mass or more or 99.9% by mass or more of the third resin layer may be the polyolefin, or the polyolefin and the modified polyolefin. The third resin layer may consist essentially of the polyolefin, or the polyolefin and the modified polyolefin. In this case, the third resin layer may contain inevitable impurities. The third resin layer may consist of the polyolefin, or the polyolefin and the modified polyolefin.

A thickness of the third resin layer is preferably 10 to 200 μm, and more preferably 20 to 125 μm.

It is preferable that the first resin layer is adjacent to the second resin layer, and the second resin layer is adjacent to the third resin layer.

### (Fourth Resin Layer)

The laminate according to one embodiment of the invention may comprise a fourth resin layer containing one or more resins selected from the group consisting of urethane, acryl, a polyolefin and polyester, on a side opposite to the second resin layer across the first resin layer.

The resin of the fourth resin layer is preferably a urethane resin in view of adhesion or moldability with the first resin layer, or the printed layer or the metal layer described later. Thus, the laminate excellent in ink adhesion can be provided.

FIG. 3 shows a laminate according to one embodiment of the invention.

In FIG. 3, a laminate 3 comprises a first resin layer 10, a second resin layer 20 formed thereon, and a third resin layer 30 formed thereon, and a fourth resin layer 40 is formed below the first resin layer 10 in the figure. Here, FIG. 3 is only for illustrating a layer structure, and an aspect ratio or a film thickness ratio is not necessarily accurate.

The urethane resin is preferably a reactant among diisocyanate, high molecular weight polyol and a chain extender. Specific examples of the high molecular weight polyol include polyether polyol and polycarbonate polyol.

Thus, even when the laminate is molded into a complicated non-planar shape, the fourth resin layer follows the first resin layer, whereby the laminate can be favorably formed. Further, even when the printed layer described later is formed, crazing or peeling of the printed layer can be prevented.

Specific examples of the urethane resin include HYDRAN WLS-202 (manufactured by DIC Corporation).

As the fourth resin layer, 1 to 3 layers are preferably formed.

A thickness of the fourth resin layer (thickness per layer when a plurality of the fourth layers exist) is preferably 0.01 μm or more and 3 μm or less, and more preferably 0.03 μm or more and 0.5 μm or less. If the thickness is 0.01 μm or more, sufficient ink adhesion can be obtained, and if the thickness is 3 μm or less, blocking caused by stickiness can be suppressed.

Tensile elongation at break of the fourth resin layer is preferably 150% or more and 900% or less, more preferably 200% or more and 850% or less, and particularly preferably 300% or more and 750% or less.

The tensile elongation at break is measured by applying an aqueous solution containing the resin used for the fourth resin layer onto a glass substrate with a bar coater, drying the resulting substrate at 80° C. for 1 minute, then separating the fourth resin layer from the glass substrate to prepare a sample having a thickness of 150 μm, and using the method in accordance with JIS K 7311 (1995).

If the tensile elongation at break of the fourth resin layer is 150% or more, the fourth resin layer can sufficiently follow stretching of the first resin layer during thermoforming, whereby a crack or crazing or peeling of the printed layer or the metal layer can be suppressed. If the tensile elongation at break is 900% or less, the laminate is excellent in water resistance.

A softening temperature of the fourth resin layer is preferably 50° C. or higher and 180° C. or lower, more preferably 90° C. or higher and 170° C. or lower, and particularly preferably 100° C. or higher and 165° C. or lower.

The softening temperature is determined by applying an aqueous solution containing the resin used for the fourth resin layer onto a glass substrate with a bar coater, drying the resulting substrate at 80° C. for 1 minute, then separating the fourth resin layer from the glass substrate to prepare a sample having a thickness of 150 μm, and measuring a flow starting temperature by using a Koka-type flowtester (“constant testing force extrusion shape capillary rheometer flowtester CFT-500EX,” manufactured by Shimadzu Corporation).

If the softening temperature of the fourth resin layer is 50° C. or higher, strength of the fourth resin layer at an ordinary temperature is sufficient, and crazing or peeling of the printed layer or the metal layer can be suppressed. If the softening temperature is 180° C. or lower, the fourth resin layer is sufficiently softened during thermoforming, and a crack of the fourth resin layer or crazing or peeling of the printed layer or the metal layer can be suppressed.

### (Other Layers)

The laminate may comprise the printed layer (also referred to as a printed matter) on a side opposite to the first resin layer across the fourth resin layer. A shape of the printed layer is not particularly limited, and specific examples thereof include various shapes such as a solid shape, a carbon-like shape and a wood grain shape.

A thickness of the printed layer is ordinarily 1 to 50 μm.

The laminate may comprise the metal layer containing metal or metal oxide on a side opposite to the first resin layer across the fourth resin layer. Metal of the metal or the metal oxide is not particularly limited, as long as the metal can provide the laminate with a metal-like design, and specific examples thereof include tin, indium, chromium, aluminum, nickel, copper, silver, gold, platinum, zinc, and alloy containing at least one kind thereof. The materials may be used in one kind alone, or in combination of two or more kinds.

Among the materials, specific examples thereof preferably include tin, indium and aluminum from a viewpoint of extensibility. Thus, the crack becomes hard to be generated when the laminate is three-dimensionally molded.

The laminate may comprise a binder layer on the surface opposite to the fourth resin layer across the printed layer. The binder layer can improve bondability between the laminate (decorative sheet) and the molding resin described later.

A material used for the binder layer is not particularly limited, and a polyolefin can be used, for example. The polyolefin is as described above.

A thickness of the binder layer is ordinarily 5 to 50 μm.

The binder layer can be laminated by printing on the surface opposite to the fourth resin layer across the printed layer.

A thickness of the laminate according to one embodiment of the invention is 50 to 500 μm, preferably 100 to 400 μm, and more preferably 200 to 300 μm, for example.

### [Decorative Sheet]

The decorative sheet can be obtained by peeling the second resin layer, or the second resin layer and the third resin layer from the laminate according to one aspect of the invention. In the decorative sheet, the fine uneven shape is ordinarily partly or wholly formed on the surface thereof, and a design such as a mat-like design and an emboss-like design is expressed by the shape, for example. Various designs can be expressed by changing the resins used for the second resin layer to adjust the uneven shape on the surface of the resin layer. Specific examples of the uneven shape include a concave shape, a convex shape, an uneven shape, a cylindrical convex shape and a cylindrical concave shape. Further, density, depth and/or height of the uneven shape can be changed, and therefore the decorative sheet can also be provided with functionality such as an antiglare effect.

Arithmetic average roughness Ra on the surface of the decorative sheet according to one embodiment of the invention is preferably 0.05 μm or more, more preferably 0.10 μm or more, and ordinarily 0.50 μm or less. The arithmetic average roughness Ra is measured by the method described in Examples.

The arithmetic average roughness Ra of the interface between the first resin layer and the second resin layer in the laminate according to one embodiment of the invention is ordinarily identical to the arithmetic average roughness Ra of the surface of the decorative sheet according to one embodiment of the invention.

Surface gloss of the decorative sheet according to one embodiment of the invention is preferably 5 to 70%. The surface gloss is measured by the method described in Examples.

An average value of height (depth) of the uneven shape existing in the decorative sheet according to one embodiment of the invention from the surface of the decorative sheet is preferably 0.2 to 3.0 μm, and more preferably 0.5 to 1.5 μm. The average value is measured by the method described in Examples.

An average uneven diameter of the uneven shape existing in the decorative sheet according to one embodiment of the invention is preferably 1.0 to 10.0 μm, and more preferably 2.0 to 8.0 μm. The average uneven diameter is measured by the method described in Examples.

The uneven shapes existing in the decorative sheet according to one embodiment of the invention exist preferably in the number of 30 to 200 per 1000 pmt. The number is measured by the method described in Examples.

A haze value of the decorative sheet according to one embodiment of the invention is preferably 20 to 75%. The haze value is measured by the method described in Examples.

The decorative sheet according to one embodiment of the invention may comprise a hard coat layer (a material is an acrylic resin or an inorganic substance such as titanium oxide, for example) on the surface for increasing the hardness. The hard coat layer is ordinarily provided by peeling the second resin layer, or the second resin layer and the third resin layer, and then applying the material to a peeled surface. In addition, even if the hard coat layer is provided, the design performance by the uneven shape on the surface of the decorative sheet is not influenced, and the appearance of the decorative sheet is unchanged.

It is considered that the uneven shape of the decorative sheet according to one embodiment of the invention is formed by the sea-island structure of the second resin layer. It is considered that the sea-island structure is formed in a process of film formation and in a process of cooling the laminate, and also depends on a constituent resin, and therefore it is considered that a shape and a size of the island portion are further varied, and arrangement thereof is further irregular in comparison with the uneven shape obtained by a conventional transfer roll (embossing roll). The decorative sheet according to one embodiment of the invention has the uneven shape, whereby the decorative sheet has the appearance and texture different from the appearance and the texture of the conventional uneven shape, but a microscopic difference cannot be distinguished by an ordinary indicator such as the arithmetic average roughness. Further, it is accompanied by significantly excessive economical expenditure to use any and all devices to conduct experiments in the unrealistic number of times in order to specify the difference, and it is difficult to comprehensively express the results in the scope of claims. Accordingly, in the invention, it is reasonably entirely impractical to directly specify the object by the structure or the characteristics thereof on filing the application.

### [Method for Producing Laminate]

A method for producing a laminate comprising a first resin layer and a second resin layer according to one aspect of the invention includes a step of co-extruding a resin constituting the first resin layer and a resin constituting the second resin layer to produce a laminated sheet, and a step of cooling the laminated sheet.

The resin constituting the first resin layer and the resin constituting the second resin layer are incompatible with each other, and the resin constituting the first resin layer contains the polyolefin, and the resin constituting the second resin layer contains the first thermoplastic resin and the second thermoplastic resin incompatible with each other, while having different solidification temperatures.

According to the above-described production method, the uneven shape can be formed in the interface between the first resin layer and the second resin layer only by the steps, and the second resin layer having a function as a protective layer can also be laminated, and therefore it is unnecessary to separately provide a step of providing the protective layer, or the like, and the laminate for decoration can be produced by the small number of steps.

The first resin layer and the second resin layer are as described above.

Co-extrusion is ordinarily performed in a temperature zone of 190 to 250° C. The first resin layer and the second resin layer, and when necessary, the third resin layer described later are melted and laminated, and the resulting material can be extruded from a general coat hanger die.

With regard to cooling in the cooling step, the laminate is preferably rapidly cooled at 80° C. or more per second until an internal temperature of the laminate reaches the solidification temperature or lower. Thus, when the polypropylene is used for the first resin layer, the crystal structure can be formed into the above-described smectic form. A cooling rate is more preferably 90° C. or more per second, and further preferably 150 to 300° C. per second.

The laminate (decorative sheet) produced by the production method described above is excellent in haze, moldability and chemical resistance.

In the steps of producing the laminated sheet, in addition to the resin constituting the first resin layer and the resin constituting the second resin layer, the resin constituting the third resin layer is co-extruded, whereby the laminate comprising the first resin layer, the second resin layer and the third resin layer can be formed.

The third resin layer is as described above.

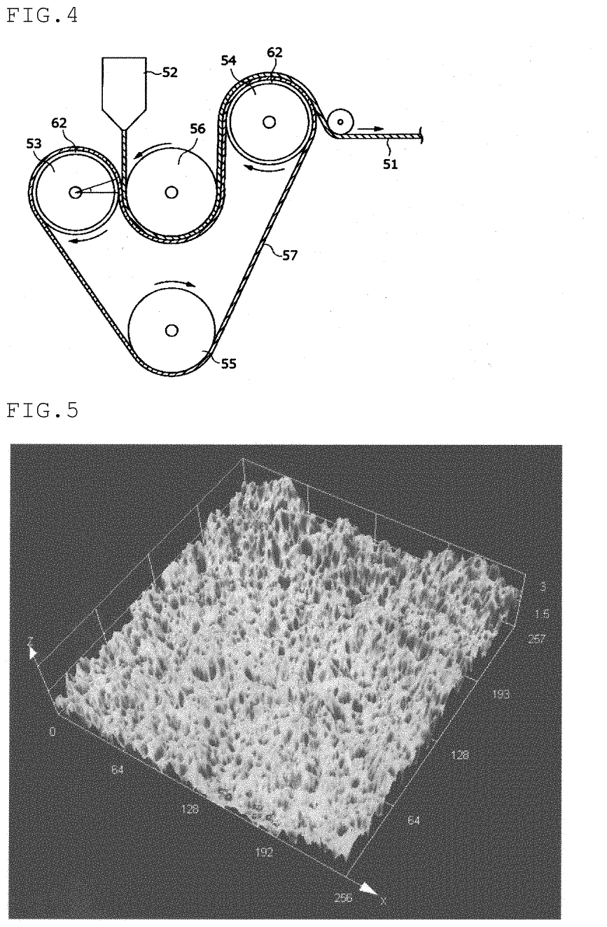

A method for producing a laminate according to one embodiment of the invention can be performed by an apparatus in FIG. 4 used in Examples.

The method may include a step of laminating the fourth resin layer on a side opposite to the second resin layer across the first resin layer, in addition to the steps described above. Specific examples of a method of laminating the fourth resin layer include application by a gravure coater, a kiss coater, a bar coater or the like.

After application, the resulting material may be dried. The resulting material is dried at 80° C. for 1 minute, for example.

The fourth resin layer is as described above.

The method may include a step of applying printing on a side opposite to the first resin layer across the fourth resin layer. Thus, the above-described printed layer is formed. As a printing method, a general printing method such as a screen printing method, an offset printing method, a gravure printing method, a roll coating method and a spray coating method can be used. In particular, the screen printing method is preferred because an ink film thickness can be increased and therefore an ink crack is hard to be generated upon molding the laminate into a complicated shape. For example, in the case of the screen printing, ink excellent in stretching during molding is preferred, and specific examples thereof can include FM3107 high concentration white and SIM3207 high concentration white, manufactured by Jujo Chemical Co., Ltd., but are not limited thereto.

The method may include a step of providing the metal layer containing metal or metal oxide on a side opposite to the first resin layer across the fourth resin layer. A method for forming the metal layer is not particularly limited, but from a viewpoint of providing the laminate with a metal-like design having high texture and high-class impression, for example, a vapor deposition method, a vacuum deposition method, a sputtering method, an ion plating method or the like, using the above-described metal, is preferred. In particular, the vacuum deposition method is preferred because of low cost and small damage to a body to be deposited. Depositing conditions should be appropriately set according to a melting temperature or an evaporating temperature of the metal to be used. Further, a method for coating paste containing the above-described metal, a plating method using the above-described metal, or the like can be used.

### [Method for Producing Molded Body]

A molded body can be produced by using the laminate, or the decorative sheet obtained by peeling the second resin layer, or the second resin layer and the third resin layer, from the laminate according to one aspect of the invention described above. Specific examples of a molding method include in-mold molding, insert molding and a Three dimension Overlay Method (TOM).

The in-mold molding is a method of placing the laminate or the decorative sheet in the mold, and molding the laminate or the decorative sheet into a desired shape by pressure of the molding resin to be supplied into the mold to obtain the molded body.

The in-mold molding is preferably performed by attaching the laminate or the decorative sheet to the mold and supplying the molding resin to integrate the molding resin with the laminate or the decorative sheet.

The insert molding is a method of preliminarily shaping a body to be shaped to be placed in the mold, and filling the molding resin in the shape to obtain the molded body. The insert molding can provide a further complicated shape.

The insert molding is preferably performed by shaping the laminate or the decorative sheet so as to match the mold, attaching the shaped laminate or decorative sheet to the mold, and supplying the molding resin to integrate the molding resin with the shaped laminate or decorative sheet.

The shaping (preliminary shaping) so as to match the mold is preferably performed by vacuum forming, pressure forming, vacuum and pressure forming, press molding, plug-assist molding, or the like.

The molding resin is preferably a moldable thermoplastic resin. Specific examples thereof include polypropylene, polyethylene, polycarbonate, an acetylene-styrene-butadiene copolymer and an acrylic polymer, but are not limited thereto. A fiber or an inorganic filler such as talc may be added thereto.

Supplying is preferably performed by injection, and pressure is preferably 5 MPa or more and 120 MPa or less. A mold temperature is preferably 20° C. or higher and 90° C. or lower.

The TOM preferably includes arranging a core material in a chamber box, arranging the laminate or the decorative sheet above the core material, reducing pressure in the chamber box, heating and softening the laminate or the decorative sheet, bringing the laminate or the decorative sheet into contact with an upper surface of the core material, and pressing the heated and softened laminate or decorative sheet to the core material to coat the laminate or the decorative sheet on the core material.

After heating and softening the laminate or the decorative sheet, the laminate or the decorative sheet is preferably brought into contact with the upper surface of the core material. With regard to pressing, it is preferable that, in the chamber box, a side opposite to the core material across the laminate or the decorative sheet is pressurized with keeping a side in contact with the core material of the laminate or the decorative sheet in reduced pressure.

The core material may be in a convex form or a concave form, and specific examples thereof include a resin, metal and ceramic having a three-dimensional curve. Specific examples of the resin include a resin similar to the resin used for the molding described above.

Specifically, the chamber box configured of upper and lower two molding chambers separable from each other is preferably used.

First, the core material is placed and set on a table in the lower molding chamber. The laminate or the decorative sheet being an object to be molded is fixed onto an upper surface of the lower molding chamber with a clamp. On the occasion, pressure inside the upper and lower molding chambers is atmospheric pressure.

Then, the upper molding chamber is descended to bond the upper and lower molding chambers into a closed state inside the chamber box. Both insides of the upper and lower molding chambers are formed into a vacuum suction state from an atmospheric pressure state by a vacuum tank.

After the insides of the upper and lower molding chambers are formed into the vacuum suction state, the decorative sheet is heated by turning on a heater. Then, the table in the lower molding chamber is ascended with keeping the insides of the upper and lower molding chambers in the vacuum state.

Then, vacuum inside the upper molding chamber is opened to introduce the atmospheric pressure thereinto, whereby the laminate or the decorative sheet being the object to be molded is pressed onto the core material and is overlaid (molded). In addition, compressed air is supplied into the upper molding chamber, whereby the laminate or the decorative sheet being the object to be molded can also be adhered onto the core material with larger force.

After completion of overlay, the heater is turned off, and vacuum inside the lower molding chamber is also opened and returned to the atmospheric pressure, and the upper molding chamber is ascended to take out a product in which a decorated and printed laminate or decorative sheet is coated as a surface material.

Timing of peeling the second resin layer, or the second resin layer and the third resin layer, from the laminate according to one aspect of the invention is preferably after molding involving heating. Thus, the uneven shape on the surface of the decorative sheet is protected by the second resin layer, and maintained also during heat treatment. On the other hand, the timing is not limited to the timing after molding involving heating, and may be before the molding involving heating.

### [Molded Body]

A molded body according to one aspect of the invention can be obtained by the above-described production method. The decorative sheet according to one aspect of the invention exists on a surface of the molded body, and therefore a shape of the surface ordinarily has characteristics similar to the characteristics of the decorative sheet according to one aspect of the invention described above. Further, in a manner similar to the decorative sheet according to one aspect of the invention, it is reasonably entirely impractical to directly specify the molded body by the structure or the characteristics thereof upon filing the application.

The molded body according to one aspect of the invention can be used in a computer component of a desktop personal computer, a notebook personal computer or the like, a mobile phone component, electric and electronic equipment, a personal digital assistant, a home electronics component, a toilet seat, an automobile component, a motorcycle component, an industrial material, a building material, and the like.

### EXAMPLES

### Example 1

### [Production of Laminate and Decorative Sheet]

A laminate was produced using a production apparatus shown in FIG. 4. The production apparatus shown in FIG. 4 has a T-die 52 of an extruder, a first cooling roll 53, a second cooling roll 54, a third cooling roll 55, a fourth cooling roll 56 and a metal endless belt 57.

Operation of the apparatus will be described. A material constituting each layer of the laminate is melted with a separate extruder (not shown) for every layer and extruded from the T-die 52, and each melted resin extruded from the T-die 52 is interposed between the metal endless belt 57 and the fourth cooling roll 56 on the first cooling roll 53 into a laminated material of the melted resins. In this state, the melted resins are pressure-welded with the first cooling roll 53 and the fourth cooling roll 56 and simultaneously rapidly cooled into a laminate 51. The laminate 51 is subsequently interposed between the metal endless belt 57 and the fourth cooling roll 56 in a circular arc part corresponding to a substantially lower semicircle of the fourth cooling roll 56, and pressure-welded in a planar form. The laminate 51 is pressure-welded in the planar form and cooled with the fourth cooling roll 56, and then the laminate 51 adhered to the metal endless belt 57 is moved onto the second cooling roll 54 together with turning of the metal endless belt 57. In a manner similar to the above description, the laminate 51 is pressure-welded in a planar form with the metal endless belt 57 in a circular arc part corresponding to a substantially upper semicircle of the second cooling roll 54, and cooled again, and then peeled from the metal endless belt 57. In addition, an elastic material 62 made of nitrile-butadiene rubber (NBR) is coated on surfaces of the first cooling roll 53 and the second cooling roll 54.

Specifically, the operation is as described below.

As described below, a material of a first resin layer, a material of a second resin layer and a material of a third resin layer were put in an extruder for the first resin layer, an extruder for the second resin layer and an extruder for the third resin layer, respectively.

### (Material of First Resin Layer)

Polypropylene (“Prime Polypro F-133A,” manufactured by Prime Polymer Co., Ltd., melt flow index: 3 g/10 min, homopolypropylene): 80% by mass
Modified polyolefin (“MODIC P-664V,” manufactured by Mitsubishi Chemical Corporation, melt flow index: 3.2 g/10 min, maleic anhydride-modified polypropylene): 20% by mass

### (Material of Second Resin Layer)

High impact polystyrene (“475D,” manufactured by PS Japan Corporation, melt flow index: 2.0 g/10 min): 80% by mass
Modified polystyrene (“EPOCROS RPS-1005,” manufactured by Nippon Shokubai Co., Ltd., melt flow index: 6 to 10 g/10 min, oxazoline group-containing reactive polystyrene): 20% by mass

The above-described high impact polystyrene has a sea-island structure in which dispersed phases (island portion) formed of polybutadiene (second thermoplastic resin) are dispersed in a continuous phase (sea portion) formed of polystyrene (first thermoplastic resin). Polystyrene and polybutadiene are incompatible with each other. A solidification temperature of polystyrene (crystalline thermoplastic resin) is 100° C., and a solidification temperature of polybutadiene (amorphous thermoplastic resin) is −85° C. Modified polystyrene was used by previously pelletizing (average particle diameter: 3 mm) a powdered raw material.

### (Material of Third Resin Layer)

Polypropylene used in the first resin layer: 65% by mass
Modified polyolefin used in the first resin layer: 35% by mass

A material constituting the first resin layer and a material constituting the second resin layer are incompatible with each other.

A melt flow index of each resin was measured at a measuring temperature of 230° C. and a load of 2.16 kg in accordance with JIS K 7210.

The materials were extruded under conditions described below, while each component was kneaded with each extruder, to obtain a laminate.
Diameter of the extruder for the first resin layer: 75 mm
Diameter of the extruder for the second resin layer: 50 mm
Diameter of the extruder for the third resin layer: 65 mm
Extrusion temperature: 230° C.
Width of the T-die 52: 900 mm
Take-off speed of the laminate: 5 m/min
Surface temperatures of the fourth cooling roll 56 and the metal endless belt 57: 20° C.
Cooling rate: 200° C./sec

The laminate obtained had the configuration described below.
Layer structure: the first resin layer/the second resin layer/the third resin layer
Thickness of the first resin layer: 200 μm
Thickness of the second resin layer: 5 μm
Thickness of the third resin layer: 45 μm
Thickness of the whole laminate: 250 μm

The thickness of each layer and the thickness of the laminate as a whole were measured by observing a cross-section using a phase contrast microscope (“ECLIPSE 80i” manufactured by Nikon Corporation). When the second resin layer was observed with a transmission electron microscope (TEM), the laminate was able to be confirmed to have a sea-island structure. The third resin layer has a higher content proportion of the modified polyolefin than a content proportion of the first resin layer, and therefore the third resin layer has an acid number higher than an acid number of the first resin layer.

From the laminate obtained, the second resin layer and the third resin layer were peeled to obtain a decorative sheet (first resin layer). A surface of the decorative sheet obtained had mat-like appearance.

The evaluation described below was performed on the decorative sheet obtained.

### [Evaluation of Decorative Sheet (Characteristics of Resin)]

### (Isotactic Pentad Fraction)

A ¹³C-NMR spectrum was evaluated on polypropylene in the decorative sheet to measure an isotactic pentad fraction. Specifically, according to attribution of peaks proposed in “Macromolecules, 8, 687 (1975)” by A. Zambelli et al., the measurement was performed using an apparatus, conditions and a calculation formula as described below.

### (Apparatus and Conditions)

Apparatus: ¹³C-NMR spectrometer (“JNM-EX400” model, manufactured by JEOL Ltd.)

Method: complete proton decoupling method (concentration: 220 mg/mL)

Solvent: mixed solvent of 1,2,4-trichlorobenzene and hexadeuterobenzene (90:10 (volume ratio))

Temperature: 130° C.

Pulse width: 45°

Pulse repetition time: 4 seconds

Accumulation: 10,000 times

Isotactic pentad fraction [mmmm]=m/S×100 (Calculation Formula)

(where, S represents signal intensity of side chain methyl carbon atoms in all propylene units, and m represents a meso pentad chain (21.7 to 22.5 ppm).)

The isotactic pentad fraction was 98 mol %.

### (Measurement of Crystallization Rate)

A crystallization rate was measured on polypropylene used in the decorative sheet using a differential scanning calorimeter (DSC) (“Diamond DSC,” manufactured by PerkinElmer, Inc.). Specifically, the polypropylene was heated from 50° C. to 230° C. at 10° C./min, held at 230° C. for 5 minutes, and cooled from 230° C. to 130° C. at 80° C./min, and then crystallized by being held at 130° C. Measurement was started on a heat quantity change from a time point at which the polypropylene reached 130° C. to obtain a DSC curve. The crystallization rate was determined from the DSC curve obtained according to the procedures (i) to (iv) described below.

(i) A line obtained by approximating, by a straight line, a heat quantity change from a time point of 10 times the time from starting of measurement to a maximum peak top to a time point of 20 times the time was applied as a baseline.

(ii) An intersection point between a tangent having an inclination at an inflection point of a peak and the baseline was determined to determine a crystallization starting time and a crystallization ending time.

(iii) A time from the crystallization starting time obtained to a peak top was measured as a crystallization time.

(iv) The crystallization rate was determined from a reciprocal of the crystallization time obtained.

The crystallization rate was 0.1 min⁻¹.

### (Confirmation of Crystal Structure)

A crystal structure of polypropylene in the decorative sheet was confirmed by Wide-Angle X-ray Diffraction (WAXD) with reference to the method by T. Konishi (Macromolecules, 38, 8749, 2005). An analysis was conducted on an X-ray diffraction profile by separating peaks in an amorphous phase, a mesophase and a crystal phase, respectively to determine an existence ratio from a peak area attributed to each phase.

Polypropylene used in the decorative sheet obtained was confirmed to have a smectic form.

### (Differential Scanning Calorimetry)

Measurement was performed on polypropylene used in the decorative sheet using the same differential scanning calorimeter as the differential scanning calorimeter in (Measurement of crystallization rate). Specifically, polypropylene was heated from 50° C. to 230° C. at 10° C./min to observe an endothermic peak and an exothermic peak. If the endothermic and exothermic peaks obtained were observed, the polypropylene was confirmed to have the exothermic peak having 1.7 J/g on a lower temperature side of a maximum endothermic peak.

### [Evaluation of Decorative Sheet (Haze Value)]

Total haze was measured on the decorative sheet using a haze meter (“NDH 2000,” manufactured by Nippon Denshoku Industries Co., Ltd.). Table 1 shows the results.

### [Evaluation of Decorative Sheet (Surface Gloss)]

Measurement was performed on a surface formed by peeling the second resin layer in the decorative sheet, in accordance with JIS K 7015. This operation was repeated 5 times on one sample, and an average value thereof was taken as a representative value. A gloss meter (“VG-2000,” manufactured by Nippon Denshoku Industries Co., Ltd.) was used for the measurement. Table 1 shows the results.

### [Evaluation of Decorative Sheet (Surface Shape)]

A surface shape on a side on which the second resin layer of the decorative sheet was laminated was observed with a 3D laser microscope (“LEXT 4000LS,” manufactured by Olympus Corporation) to measure (calculate) arithmetic average roughness, an average uneven height difference, an average uneven diameter, and the number of uneven shapes per unit area, respectively. Table 1 shows the results.

Specific measuring conditions and measuring method are as described below.

Objective lens: MPLAPONLEXT 50×

Optical zoom: 1×

Measurement pitch: 0.06 μm

Scan mode: High precision color

Laser intensity: 100%

Cut-off value: 800 μm

Observation range: 257 μm×257 μm/sample

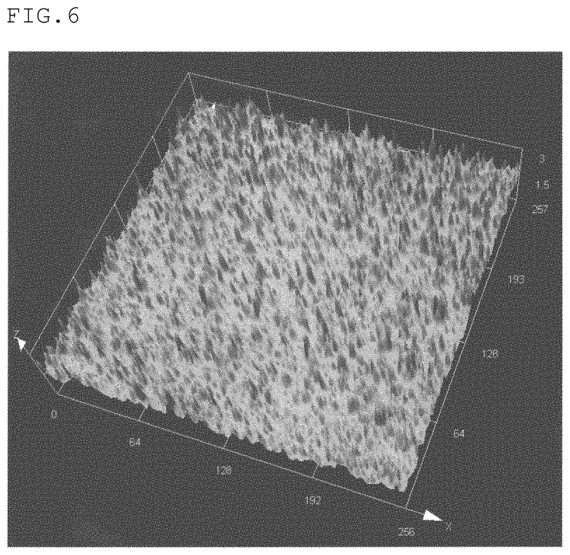

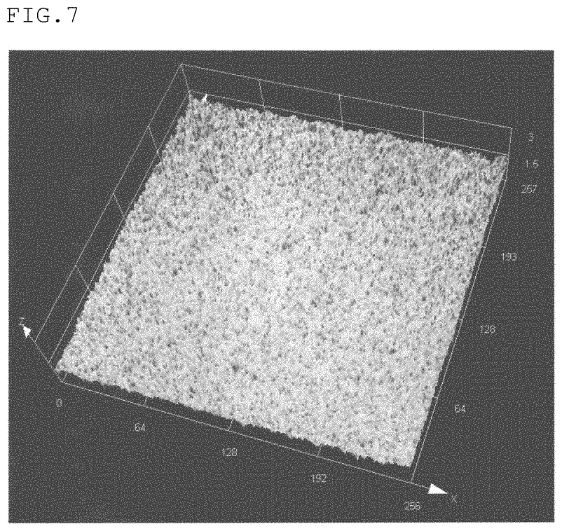

FIG. 5 shows an observed image of the surface shape of the decorative sheet, which was obtained by the 3D laser microscope. Further, FIG. 6 shows an observed image of the surface shape of the second resin layer peeled on a side of the first resin layer.

A unit of a numeric value in FIGS. 5 and 6 is μm.

### (Arithmetic Average Roughness)

A central portion of the decorative sheet was cut out into a size of 10 cm×10 cm to measure roughness in an MD direction (machine direction in film formation). This operation was repeated 10 times, and an average value was taken as a representative value.

### (Average Uneven Height Difference)

A central portion of the decorative sheet was cut out into a size of 10 cm×10 cm, and in the observation range (257 μm×257 μm) in the sample, all uneven shapes formed in a predetermined range (1000 μm²) were applied as measuring objects. Height differences of observed uneven parts from a surface of the decorative sheet were measured, and an average value was taken as an average uneven height difference. A convex shape was taken as a positive value, and a concave shape was taken as a negative value.

### (Average Uneven Diameter)

A central portion of the decorative sheet was cut out into a size of 10 cm×10 cm, and in the observation range (257 μm×257 μm) in the sample, all uneven shapes formed in a predetermined range (1000 μm²) were applied as measuring objects. Outer diameters of observed uneven shapes were measured, and an average value was taken as an average uneven diameter.

### (Number of Uneven Shapes Per Unit Area)

A central portion of the decorative sheet was cut out into a size of 10 cm×10 cm, and in the observation range (257 μm×257 μm) in the sample, uneven shapes formed in a predetermined range (1000 μm²) were visually counted. This operation was repeated 10 times, and an average value was taken as the number of uneven shapes per unit area.

### Example 2

A laminate, a decorative sheet and a molded body were produced and evaluated in the same manner as in Example 1 except that high impact polystyrene (“H0103,” manufactured by PS Japan Corporation, melt flow index: 2.6 g/10 min) was used in place of high impact polystyrene “475D” in the extruder for the second resin layer. Table 1 shows the results. When the second resin layer of the laminate obtained was observed with a transmission electron microscope (TEM), the laminate was able to be confirmed to have a sea-island structure. Further, a surface of the decorative sheet obtained had mat-like appearance. FIG. 7 shows an observed image of a surface shape of the decorative sheet, which was obtained by a 3D laser microscope. A unit of a numeric value in FIG. 7 is μm.

The above-described high impact polystyrene has a sea-island structure in which dispersed phases (island portion) formed of polybutadiene (second thermoplastic resin) are dispersed in a continuous phase (sea portion) formed of polystyrene (first thermoplastic resin). Further, dispersion density of polybutadiene is higher than dispersion density of “475D,” and a particle size of polybutadiene is smaller than a particle size of “475D.”

### Comparative Example 1

A laminate, a decorative sheet and a molded body were produced and evaluated in the same manner as in Example 1 except that general-purpose polystyrene (“G9305,” manufactured by PS Japan Corporation, melt flow index: 1.5 g/10 min, polymer consisting of polystyrene) was used in place of high impact polystyrene “475D” in the extruder for the second resin layer. Table 1 shows the results.

When the second resin layer of the laminate obtained was observed with a transmission electron microscope (TEM), a sea-island structure was unable to be confirmed. Further, the decorative sheet obtained in Comparative Example 1 had no uneven shape and no design performance.

TABLE 1

| | | Haze | Surface | Arithmetic | Average uneven | Average uneven | Number of |
|---|---|---|---|---|---|---|---|
| | Resin used in | value | gloss | average roughness | height difference | diameter | uneven shapes |
| | second resin layer | (%) | (%) | (μm) | (μm) | (μm) | (number/1000 μm²) |
| Example 1 | Polystyrene having | 54.0 | 18.8 | 0.22 | −1.30 | 6.79 | 106.6 |
| | sea-island structure | | | | | | |
| Example 2 | Polystyrene having | 26.3 | 54.4 | 0.09 | −0.57 | 2.75 | 46.27 |
| | sea-island structure | | | | | | |
| Comparative | General-purpose | 4.2 | 146.5 | 0.01 | 0.00 | 0.00 | 0 |
| Example 1 | polystyrene | | | | | | |

### Example 3

### [Production and Evaluation of Molded Body]

Both surfaces of the laminate obtained in Example 1 were heated to a surface temperature of 160° C. using an infrared heater, and then vacuum and pressure forming was performed to obtain a laminate shaped (shaped laminate). Pressure of pressure forming was set to be 0.3 MPa.

The shaped laminate was attached to a mold (plate mold, 65 mm wide×150 mm long×2 mm thick, side gate: one place, center of long side) and clamped in such a manner that the first resin layer faces a side on which the molding resin described later is supplied, the molding resin (“Prime Polypro J705UG,” manufactured by Prime Polymer Co., Ltd., melt flow index: 9.0 g/10 min, block polypropylene) was supplied into the mold with an injection molding machine (“IS80EPN,” manufactured by Toshiba Machine Co., Ltd.), and the molding resin was integrated with the shaped laminate to produce a molded body (insert molding). A temperature of the mold was adjusted to 45° C., a temperature of the molding resin was adjusted to 240° C., and an injection rate of the molding resin was adjusted to 18 mm/sec.

Surface gloss, arithmetic average roughness and an average uneven height difference were measured, in the same manner as in Example 1, on a molded body surface emerged by peeling the second resin layer and the third resin layer from a surface of the shaped laminate integrated with the molded body. Table 2 shows the results.

### Example 4

### [Production and Evaluation of Molded Body]

A molded body was produced and evaluated in the same manner as in Example 3 except that the second resin layer and the third resin layer were peeled from the shaped laminate before the shaped laminate was attached to the mold. Table 2 shows the results.

TABLE 2

| | | | Arithmetic | Average |
|---|---|---|---|---|
| | | Surface | average | uneven height |
| | Timing of peeling | gloss | roughness | difference |
| | second and third layers | (%) | (μm) | (μm) |
| Example 3 | After insert molding | 18.5 | 0.21 | −1.28 |
| Example 4 | Before insert molding | 26.3 | 0.18 | −1.03 |

Tables 1 and 2 show that, if the laminate according to one aspect of the invention is used, the design performance of the decorative sheet is hardly changed even if molding involving heating is performed (Example 3). Further, Tables 1 and 2 show that, even when the second resin layer is peeled before molding involving heating, the design performance is not significantly adversely affected (Example 4).

Several embodiments and/or Examples of the invention have been described in detail above, but those skilled in the art will readily make a great number of modifications to the exemplary embodiments and/or Examples without substantially departing from new teachings and advantageous effects of the present invention. Accordingly, all such modifications are included within the scope of the invention.

The entire contents of the description of the Japanese application serving as a basis of claiming the priority concerning the present application to the Paris Convention are incorporated by reference herein.

1. A laminate, comprising a first resin layer and a second resin layer,
wherein a resin constituting the first resin layer and a resin constituting the second resin layer are incompatible with each other,
the first resin layer contains a polyolefin,
the second resin layer contains a first thermoplastic resin and a second thermoplastic resin, and
the first thermoplastic resin and the second thermoplastic resin are incompatible with each other, while having different solidification temperatures.

2. The laminate according to claim 1, wherein the second resin layer has a sea-island structure in which the first thermoplastic resin constitutes a sea portion and the second thermoplastic resin constitutes an island portion.

3. The laminate according to claim 1, wherein the solidification temperature of the first thermoplastic resin is higher than the solidification temperature of the second thermoplastic resin.

4. The laminate according to claim 1, wherein an interface between the first resin layer and the second resin layer partly or wholly has an uneven shape.

5. The laminate according to claim 1, wherein the laminate can be separated in the interface between the first resin layer and the second resin layer.

6. The laminate according to claim 1, wherein the first thermoplastic resin of the second resin layer contains one or more resins selected from the group consisting of polystyrene, polyacrylonitrile, polyamide, an ethylene-vinyl alcohol copolymer, polyethylene terephthalate, a polyolefin and polylactic acid.

7. The laminate according to claim 1, wherein the second thermoplastic resin of the second resin layer contains a rubber-like polymer.

8. The laminate according to claim 7, wherein the rubber-like polymer is one or more selected from the group consisting of diene-based rubber, a thermoplastic elastomer and an ionomer.

9. The laminate according to claim 1, wherein the first resin layer contains polypropylene.

10. The laminate according to claim 9, wherein a crystallization rate of the polypropylene at 130° C. is 2.5 min⁻¹ or less.

11. The laminate according to claim 9, wherein the polypropylene contains a smectic form.

12. The laminate according to claim 9, wherein the polypropylene has an exothermic peak having 1 J/g or more on a low-temperature side of a maximum endothermic peak in a curve obtained by differential scanning calorimetry.

13. The laminate according to claim 9, wherein an isotactic pentad fraction of the polypropylene is 85 mol % to 99 mol %.

14. The laminate according to claim 1, comprising a third resin layer containing a polyolefin on a side opposite to the first resin layer across the second resin layer.

15. The laminate according to claim 14, wherein the first resin layer and the third resin layer contain a modified polyolefin, and a content proportion of the modified polyolefin in the third resin layer is higher than a content proportion of the modified polyolefin in the first resin layer.

16. The laminate according to claim 15, wherein the modified polyolefin contained in the first resin layer is identical to the modified polyolefin contained in the third resin layer.

17. The laminate according to claim 1, comprising a fourth resin layer containing one or more resins selected from the group consisting of urethane, acryl, a polyolefin and polyester, on a side opposite to the second resin layer across the first resin layer.

18. The laminate according to claim 17, wherein tensile elongation at break of the fourth resin layer is 150% or more and 900% or less, and a softening temperature thereof is 50° C. or higher and 180° C. or lower.

19. The laminate according to claim 17, comprising a printed layer on a side opposite to the first resin layer across the fourth resin layer.

20. The laminate according to claim 17, comprising a metal layer containing metal or metal oxide on a side opposite to the first resin layer across the fourth resin layer.

21. A decorative sheet, obtained by peeling the second resin layer, or the second resin layer and the third resin layer from the laminate according to claim 1.

22. A method for producing a laminate comprising a first resin layer and a second resin layer, comprising a step of producing a laminated sheet by co-extruding a resin constituting the first resin layer and a resin constituting the second resin layer, and a step of cooling the laminated sheet,
wherein the resin constituting the first resin layer and the resin constituting the second resin layer are incompatible with each other,
the resin constituting the first resin layer contains a polyolefin,
the resin constituting the second resin layer contains a first thermoplastic resin and a second thermoplastic resin, and
the first thermoplastic resin and the second thermoplastic resin are incompatible with each other, while having different solidification temperatures.

23. The method for producing the laminate according to claim 22, wherein, in the step of producing the laminated sheet, in addition to the resin constituting the first resin layer and the resin constituting the second resin layer, a resin constituting a third resin layer is co-extruded to produce a laminate comprising the first resin layer, the second resin layer and the third resin layer.

24. The method for producing the laminate according to claim 22, comprising, after the step of cooling the laminated sheet, a step of laminating a fourth resin layer containing one or more resins selected from the group consisting of urethane, acryl, a polyolefin and polyester, on a side opposite to the second resin layer across the first resin layer.

25. The method for producing the laminate according to claim 24, comprising a step of applying printing on a side opposite to the first resin layer across the fourth resin layer.

26. The method for producing the laminate according to claim 24, comprising a step of forming a metal layer containing metal or metal oxide on a side opposite to the first resin layer across the fourth resin layer.

27. A method for producing a molded body, comprising a step of molding the laminate according to claim 1, and a step of peeling the second resin layer, or the second resin layer and the third resin layer from the molded laminate.

28. A method for producing a molded body, comprising a step of peeling the second resin layer, or the second resin layer and the third resin layer from the laminate according to claim 1 to obtain a decorative sheet, and a step of molding the decorative sheet.

29. The method for producing the molded body according to claim 27, wherein the molding is performed by attaching the laminate or the decorative sheet to a mold, and supplying a molding resin to integrate the molding resin with the laminate or the decorative sheet.

30. The method for producing the molded body according to claim 27, wherein the molding is performed by shaping the laminate or the decorative sheet so as to match a mold, attaching the shaped laminate to the mold, and supplying a molding resin to integrate the molding resin with the shaped laminate.

31. The method for producing the molded body according to claim 27, wherein
the molding comprising:
arranging a core material in a chamber box;
arranging the laminate or the decorative sheet above the core material;
reducing pressure in the chamber box;
heating and softening the laminate or the decorative sheet; and
pressing the heated and softened laminate or decorative sheet to the core material to coat the core material with the laminate or the decorative sheet.

32. A molded body, obtained by the method for producing the molded body according to claim 27.
